(19) United States
(12) Patent Application Publication
(10) Pub. No.: US 2025/0362005 A1
(43) Pub. Date: Nov. 27, 2025

(54) LIGHTING DEVICES, METHODS OF PRODUCING THE SAME, AND VEHICLES INCLUDING THE SAME

(71) Applicant: HONEYWELL INTERNATIONAL INC., Charlotte, NC (US)

(72) Inventors: Gokul Murugesan, Bangalore (IN); Anita Sure, Bangalore (IN); Craig Giffen, Urbana, OH (US); Panduranga Rao Somarowthu, Bangalore (IN); Harish Nagarajaiah, Bangalore (IN); Mitchell Henman, Urbana, OH (US)

(73) Assignee: HONEYWELL INTERNATIONAL INC., Charlotte, NC (US)

(21) Appl. No.: 18/816,533

(22) Filed: Aug. 27, 2024

(30) Foreign Application Priority Data
May 23, 2024 (IN) 202411040186

(51) Int. Cl. F21V 19/00; F21V 7/00; F21Y 107/50; F21Y 113/00

(52) U.S. Cl. CPC F21V 19/0015; F21V 7/0066; F21Y 2107/50; F21Y 2113/00

(57) ABSTRACT

Lighting devices, methods, and vehicles are provided. The devices include a unitary body formed of a metal clad printed circuit board (MCPCD). The body includes first, second, and third support members having first, second, and third support surfaces. The first and second support members are integral with each other with a bend at a boundary therebetween. First and second protruding members having first and second functional surfaces extend from the first support member, and third and fourth protruding members having third and fourth functional surfaces extend from the second support member. First and second light sources are fixed to the first and second support surfaces, respectively. The first and second light sources are operable via a circuit layer of the MCPCD. The first, second, third, and fourth functional surfaces are configured to reflect and/or block the light emitted by the first or second light source.

### CROSS REFERENCE TO RELATED APPLICATION

This application claims priority to India Provisional Patent Application No. 202411040186, filed May 23, 2024, the entire content of which is incorporated by reference herein.

### TECHNICAL FIELD

The present invention generally relates to aircraft lighting systems, and more particularly relates to a lighting device that includes a unitary body with integral light blockers and/or reflectors.

### BACKGROUND

Aircraft exterior lights serve various purposes, including signaling to other aircraft, ground personnel, and air traffic controllers. Typical exterior lights may include navigation lights, anti-collision lights, flood lights, and wing lights. These lights may promote the safety of air travel by making aircraft more visible to other aircraft and ground personnel, especially during low light conditions or adverse weather.

Modern aircraft often include multifunctional exterior lighting assemblies that include more than one light source that are configured to emit light in more than one direction. Each of these light sources may be used for a different function. However, these assemblies may require relatively complex structures that may be challenging and costly to manufacture.

Hence, there is a need for multifunctional exterior lighting assemblies for aircraft that have structures that are relatively easy and low cost to manufacture. Furthermore, other desirable features and characteristics of the present invention will become apparent from the subsequent detailed description and the appended claims, taken in conjunction with the accompanying drawings and the foregoing technical field and background.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

In various embodiments, a lighting device is provided that includes a single, unitary body formed of a metal clad printed circuit board having at least a base metal layer, a circuit layer, and a dielectric layer between the base metal layer and the circuit layer. The body includes a first support member having a first support surface, a second support member having a second support surface, wherein the first support member and the second support member are integral with each other with a bend at a boundary therebetween, a first protruding member integral with and extending from the first support member, the first protruding member having a first functional surface, a second protruding member integral with and extending from the first support member, the second protruding member having a second functional surface, a third protruding member integral with and extending from the second support member, the third protruding member having a third functional surface, and a fourth protruding member integral with and extending from the second support member, the fourth protruding member having a fourth functional surface. A first light source is fixed to the first support surface and configured to emit light therefrom. The first light source is operable via the circuit layer. The first functional surface and the second functional surface are each disposed within paths of light emitted from the first light source and configured to reflect and/or block the light emitted by the first light source. A second light source is fixed to the second support surface and configured to emit light therefrom. The second light source is operable via the circuit layer. The third functional surface and the fourth functional surface are each disposed within paths of light emitted from the second light source and configured to reflect and/or block the light emitted by the second light source.

In various embodiments, a method is provided that includes forming a single, unitary body from a metal clad printed circuit board having at least a base metal layer, a circuit layer, and a dielectric layer between the base metal layer and the circuit layer. Forming the body includes providing a first support member having a first support surface, providing a second support member having a second support surface, wherein the first support member and the second support member are integral with each other with a bend at a boundary therebetween, providing a first protruding member integral with and extending from the first support member, the first protruding member having a first functional surface, providing a second protruding member integral with and extending from the first support member, the second protruding member having a second functional surface, providing a third protruding member integral with and extending from the second support member, the third protruding member having a third functional surface, and providing a fourth protruding member integral with and extending from the second support member, the fourth protruding member having a fourth functional surface. The method includes securing a first light source to the first support surface such that the first light source is operable via the circuit layer to emit light, wherein the first functional surface and the second functional surface are each within paths of light emitted from the first light source, securing a second light source to the second support surface such that the second light source is operable via the circuit layer to emit light, wherein the third functional surface and the fourth functional surface are each within paths of light emitted from the second light source, configuring the first functional surface and the second functional surface to reflect and/or block the light emitted by the first light source, and configuring the third functional surface and the fourth functional surface to reflect and/or block the light emitted by the second light source.

In various embodiments, a vehicle is provided that includes a lighting device secured to an exterior of the vehicle. The lighting device includes a single, unitary body formed of a metal clad printed circuit board having at least a base metal layer, a circuit layer, and a dielectric layer between the base metal layer and the circuit layer. The body includes a first support member having a first support surface, a second support member having a second support surface, wherein the first support member and the second support member are integral with each other with a bend at a boundary therebetween, a first protruding member integral with and extending from the first support member, the first protruding member having a first functional surface, a second protruding member integral with and extending from the first support member, the second protruding member having a second functional surface, a third protruding member integral with and extending from the second support member, the third protruding member having a third functional surface, and a fourth protruding member integral with and extending from the second support member, the fourth protruding member having a fourth functional surface. A first light source is fixed to the first support surface and configured to emit light therefrom. The first light source is operable via the circuit layer. The first functional surface and the second functional surface are each disposed within paths of light emitted from the first light source and configured to reflect and/or block the light emitted by the first light source. A second light source is fixed to the second support surface and configured to emit light therefrom. The second light source is operable via the circuit layer. The third functional surface and the fourth functional surface are each disposed within a path of light emitted from the second light source and configured to reflect and/or block the light emitted by the second light source. The vehicle includes a user interface functionally coupled to the lighting device via the circuit layer and configured to selectively operate the first light source and the second light source to emit light therefrom, and a power supply functionally coupled to the lighting device via the circuit layer and configured to provide electrical power thereto.

Furthermore, other desirable features and characteristics of the lighting device and method will become apparent from the subsequent detailed description and the appended claims, taken in conjunction with the accompanying drawings and the preceding background.

### BRIEF DESCRIPTION OF DRAWINGS

The present disclosure will hereinafter be described in conjunction with the following drawing figures, wherein like numerals denote like elements, and wherein:

FIG. 1 schematically represents an aircraft and components of an exterior lighting system thereof in accordance with an embodiment;

FIG. 2 is a first perspective view of a lighting device in accordance with an embodiment;

FIG. 3 is a second perspective view of the lighting device of FIG. 2;

FIG. 4 is a top view of the lighting device of FIGS. 2 and 3;

FIG. 5 is a side view of the lighting device of FIGS. 2-4; and

FIG. 6 is a flowchart illustrating an exemplary method for producing a lighting device in accordance with an embodiment.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

Systems and methods disclosed herein provide for multifunctional lighting assemblies. The lighting assemblies include more than one light source that are configured to emit light in more than one direction. For convenience, the lighting assemblies will be discussed herein in reference to an exterior lighting system of an aircraft; however, the lighting assemblies are not limited to any particular application. For example, the lighting assemblies may be used on another type of mobile platform.

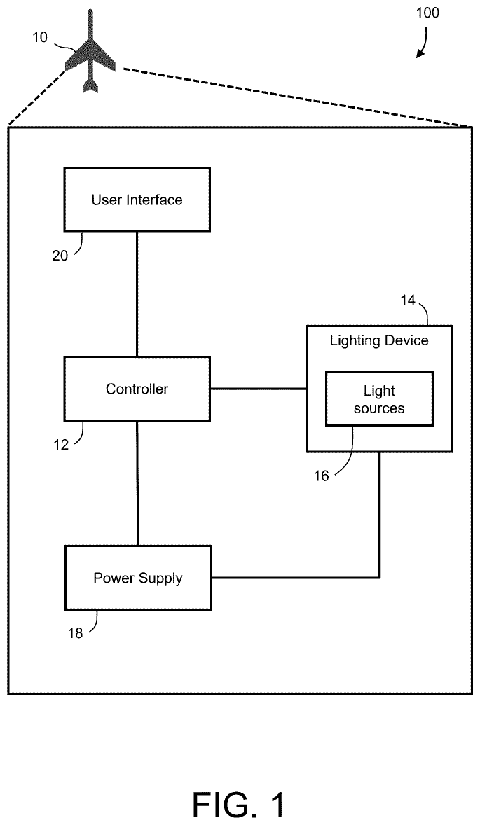

Referring now to FIG. 1, an aircraft 10 and certain systems thereof are illustrated in accordance with an exemplary and nonlimiting embodiment of the present disclosure. It should be noted that the term aircraft, as utilized herein, may include any manned or unmanned object capable of flight. Examples of aircraft may include, but are not limited to, fixed-wing aerial vehicles (e.g., propeller-powered or jet powered), rotary-wing aerial vehicles (e.g., helicopters), manned aircraft, unmanned aircraft (e.g., unmanned aerial vehicles, or UAVs), delivery drones, etc. For convenience, the systems and methods will be described in reference to a manned airplane; however, as noted the systems and methods are not limited to such application.

An exterior lighting system 100 may be utilized onboard the aircraft 10 as described herein. As schematically depicted in FIG. 1, the system 100 includes and/or is functionally coupled to the following components or subsystems, each of which may assume the form of a single device or multiple interconnected devices, including, but not limited to, a controller 12 operationally coupled to an exterior lighting device 14 having light sources 16, a power supply 18, and an optional user interface 20.

The term “controller,” as appearing herein, broadly encompasses those components utilized to carry-out or otherwise support the processing functionalities of the system 100. Accordingly, the controller 12 can encompass or may be associated with any number of individual processors, flight control computers, navigational equipment pieces, computer-readable memories, power supplies, storage devices, interface cards, and other standardized components.

In various embodiments, the controller 12 includes at least one processor, a communication bus, and a computer readable storage device or media. The processor performs the computation and control functions of the controller 12. The processor can be any custom made or commercially available processor or generally any device for executing instructions. The computer readable storage device or media may include volatile and nonvolatile storage in read-only memory (ROM), random-access memory (RAM), etc. The computer-readable storage device or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 12. The bus serves to transmit programs, data, status and other information or signals between the various components of the aircraft 10. The bus can be any suitable physical or logical means of connecting computer systems and components. This includes, but is not limited to, direct hard-wired connections, fiber optics, infrared, and wireless bus technologies.

In various embodiments, the controller 12 may be or include a lighting control module (LCM) configured to manage the operation of the exterior lighting system 100. The LCM may incorporate features such as automatic dimming or monitoring of light status.

The optional user interface 20 may be any device configured to allow a user to interact with the controller 12. In some embodiments, the user interface 20 includes various switches and/or controls within a cockpit of the aircraft 10. In various embodiments, the user interface 20 includes a touch screen display. Via various display and graphics systems processes, the controller 12 may command and control the touch screen display generating a variety of graphical user interface (GUI) objects or elements, for example, buttons, sliders, and the like, which are used to prompt a user to interact therewith to provide user input, and to activate respective functions and provide user feedback, responsive to received user input at the GUI element. The user interface 20 may be operable by the user to operate the lighting device 14, for example, to illuminate the light sources 16, adjust the intensity or pattern of the light sources 16, etc.

The power supply 18 may be any device configured to provide sufficient electrical power to the lighting device 14 for operation thereof. The electrical power may be generated by the aircraft's engines, auxiliary power unit (APU), or batteries, depending on the phase of flight and configuration of the aircraft 10.

The lighting device 14 may include various components configured to provide for illumination of the light sources 16 in accordance with their respective functions. In some embodiments, the lighting device 14 may include various wiring and connectors configured to functionally couple the lighting device 14 to an electrical system of the aircraft to, for example, transmit the electrical power from the power supply 18 to the light sources 16 and provide for control of the lighting device 14 via the user interface 20, various lenses and covers configured to focus and/or protect the light sources 16, and/or various mounting hardware such as brackets, mounts, and fasteners that are configured to secure the lighting device 14 to the structure of the aircraft 10. The light sources 16 may be any device configured to emit light, such as light-emitting diodes (LEDs), incandescent bulbs, halogen bulbs, or xenon bulbs.

The light sources 16 may provide various functions for the aircraft 10. In various embodiments, one or more of the light sources 16 may be navigation light(s) configured to illuminate to indicate an orientation and direction of travel of the aircraft 10. In some examples, the navigation light(s) may be red on the left wingtip and green on the right wingtip. In various embodiments, one or more of the light sources 16 may be strobe light(s) configured for high-intensity flashing to, for example, increase the visibility of the aircraft 10. In various embodiments, one or more of the light sources 16 may be anti-collision light(s), optionally integrated with strobe lights, that are configured to reduce the likelihood of mid-air collisions by enhancing the visibility of the aircraft 10 to other pilots. In some examples, the anti-collision light(s) may be positioned on the top and bottom of the fuselage and/or on the wingtips of the aircraft 10. In various embodiments, one or more of the light sources 16 may be taxi lights configured to illuminate an airport surface (e.g., a taxiway) while the aircraft 10 is on the ground. In various embodiments, one or more of the light sources 16 may be landing lights configured to provide additional illumination during takeoff and landing, and thereby promote the pilot's ability to see the runway and any obstacles. In some examples, the landing lights may be located on the nose or wings of the aircraft 10. In various embodiments, one or more of the light sources 16 may be wing lights configured to promote visibility of the aircraft 10 from sides thereof.

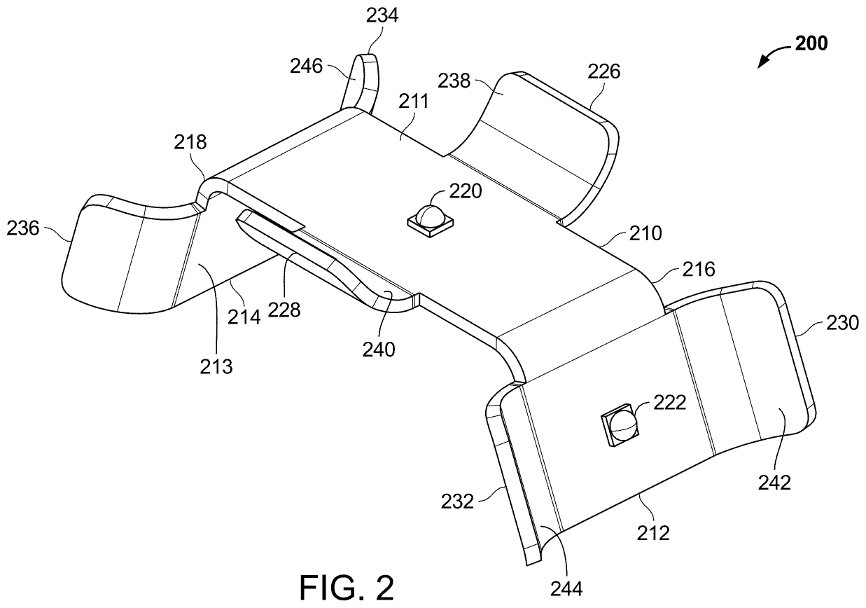

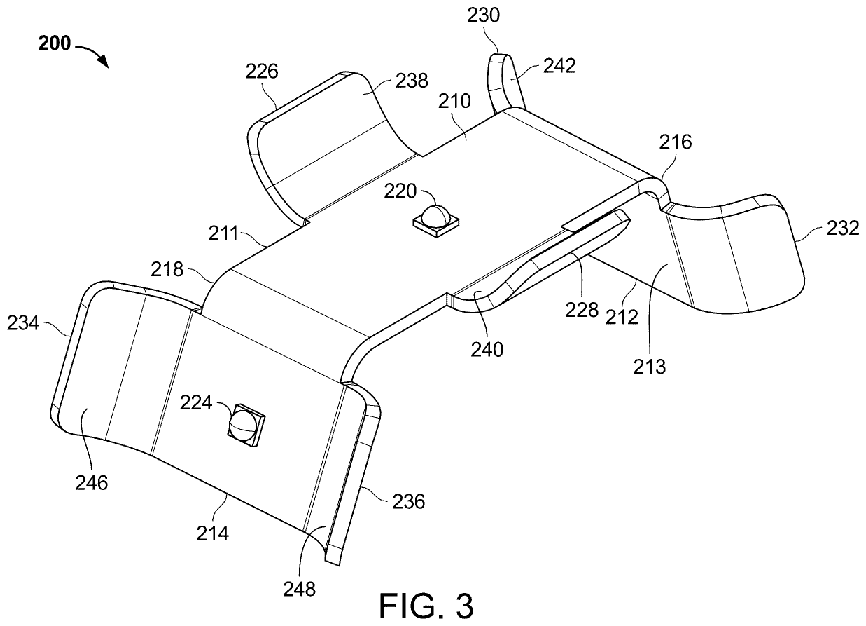

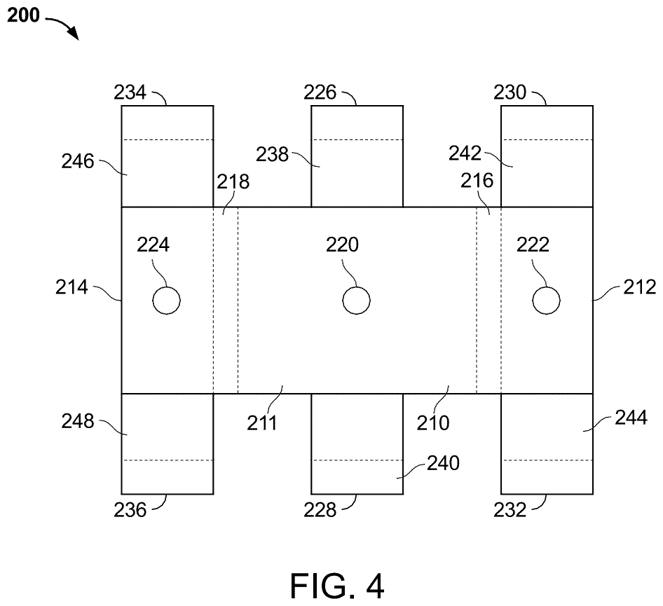

Referring now to FIGS. 2-5, and with continued reference to FIG. 1, an exemplary lighting device 200 is provided in accordance with various embodiments. In some examples, the lighting device 200 may be installed on the aircraft 10 as the lighting device 14 or a component thereof. The lighting device 200 may have various shapes and sizes. In this example, the lighting device 200 includes a unitary body having a first support member 210, a second support member 212, and a third support member 214. The first, second, and third support members 210, 212, and 214 are integral and aligned along a longitudinal axis of the lighting device 200, with the second and third support members 212 and 214 disposed on opposite ends of the first support member 210.

The body includes a first bend 216 at the boundary of the first support member 210 and the second support member 212, and a second bend 218 at the boundary of the first support member 210 and the third support member 214. Such that each of the first, second, and third support members 210, 212, and 214 are disposed in different orientations. The body includes an outward facing surface 211 and an inward facing surface 213. For embodiments in which the lighting device 200 is secured to an exterior of an aircraft, such as the lighting device 14 of the aircraft 10, the outward facing surface 211 is configured to be directed away from exterior surfaces of the aircraft and the inward facing surface 213 is configured to be directed toward the exterior surfaces of the aircraft.

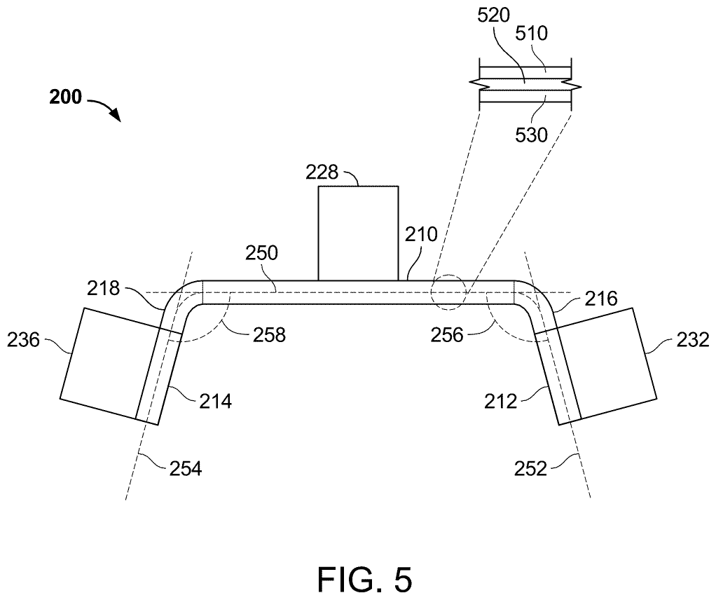

Referring to FIG. 5, the first support member 210 may extend along a first axis 250, the second support member 212 may extend along a second axis 252, and the third support member 214 may extend along a third axis 254. A first angle 256 may be defined between the first axis 250 and the second axis 252, and a second angle 258 may be defined between the first axis 250 and the third axis 254. In various embodiments, an absolute value of the first angle 256 and an absolute value of the second angle 258 may be equal or different. In various embodiments, the absolute value of the first angle 256 and the absolute value of the second angle 258 may each be 90 to 165 degrees, such as 100 to 160 degrees, such as 110 to 150 degrees, such as 120 to 140 degrees, such as 125 to 135 degrees.

The lighting device 200 may include various quantities of light sources secured to one or more of the first, second, and third support members 210, 212, and 214. In this example, a first light source 220 is secured to the first support member 210, a second light source 222 is secured to the second support member 212, and a third light source 224 is secured to the third support member 214. The first, second, and third light sources 220, 222, and 224 are configured to be independently illuminated to emit light in directions away from the first, second, and third support members 210, 212, and 214, respectively.

The lighting device 200 may include protruding members extending outwardly from sides of the first, second, and/or third support members 210, 212, and 214. In this example, the lighting device 200 includes a first protruding member 226 and a second protruding member 228 extending from oppositely disposed sides of the first support member 210, a third protruding member 230 and a fourth protruding member 232 extending from oppositely disposed sides of the second support member 212, and a fifth protruding member 234 and a sixth protruding member 236 extending from oppositely disposed sides of the third support member 214. The first and second protruding members 226 and 228 are aligned in a direction perpendicular to the first axis 250 and centered about the first light source 220, the third and fourth protruding members 230 and 232 are aligned in a direction perpendicular to the second axis 252 and centered about the second light source 222, and the fifth and sixth protruding members 234 and 236 are aligned in a direction perpendicular to the third axis 254 and centered about the third light source 224.

In this example, the first, second, third, fourth, fifth, and sixth protruding members 226, 228, 230, 232, 234, and 236 have curved structures. For embodiments in which the lighting device 200 is secured to an exterior of an aircraft, the first, second, third, fourth, fifth, and sixth protruding members 226, 228, 230, 232, 234, and 236 would be curved in directions away from the exterior surfaces of the aircraft. Alternatively, the first, second, third, fourth, fifth, and sixth protruding members 226, 228, 230, 232, 234, and 236 may have planar structures extending at non-zero angles from the first, second, and third support members 210, 214, and 216 to which they are connected, or faceted surfaces including two or more planar surfaces that, in combination, form a substantially curved structure.

Regardless of their specific structure, each of the first, second, third, fourth, fifth, and sixth protruding members 226, 228, 230, 232, 234, and 236 are configured to extend into paths of light emitted from the first, second, or third light sources 220, 222, and 224. Specifically, the first and second protruding members 226 and 228 are configured to extend into the path of light emitted from the first light source 220, the third and fourth protruding members 230 and 232 are configured to extend into the path of light emitted from the second light source 222, and the fifth and sixth protruding members 234 and 236 are configured to extend into the path of light emitted from the third light source 224.

In some embodiments, the first, second, third, fourth, fifth, and sixth protruding members 226, 228, 230, 232, 234, and 236 may have first, second, third, fourth, fifth, and sixth functional surfaces 238, 240, 242, 244, 246, and 248, respectively. In some embodiments, one or more of the first, second, third, fourth, fifth, and sixth functional surfaces 238, 240, 242, 244, 246, and 248 may be configured to block light radiated thereupon. In some embodiments, one or more of the first, second, third, fourth, fifth, and sixth functional surfaces 238, 240, 242, 244, 246, and 248 may be configured to reflect light radiated thereupon. In some examples, a reflective object or material may be secured to one or more of the first, second, third, fourth, fifth, and sixth protruding members 226, 228, 230, 232, 234, and 236 to define a reflective surface on one or more of the first, second, third, fourth, fifth, and sixth functional surfaces 238, 240, 242, 244, 246, and 248. For example, a reflective tape may be bonded to one or more of the first, second, third, fourth, fifth, and sixth protruding members 226, 228, 230, 232, 234, and 236. In some embodiments, one or more of the first, second, third, fourth, fifth, and sixth functional surfaces 238, 240, 242, 244, 246, and 248 may be configured to both block and reflect light radiated thereupon.

In some embodiments, the body of the lighting device 200 may be formed of a metal clad printed circuit board having at least a base metal layer (e.g., a base metal layer 530 in FIG. 5), a circuit layer (e.g., a circuit layer 510 in FIG. 5), and a dielectric layer (e.g., a dielectric layer 520 in FIG. 5) between the base metal layer and the circuit layer. In such embodiments, the lighting device 200 may be installed on an exterior of the aircraft 10 with the first, second, and third light sources 220, 222, and 224 functionally coupled to an electrical system of the aircraft 10 via the circuit layer. In such examples, the first, second, and third light sources 220, 222, and 224 may be configured to receive the electrical power from the power supply 18 through the circuit layer, and configured to be independently operable using the user interface 20 of the aircraft 10.

In various embodiments, the base metal layer of one or more of the first, second, third, fourth, fifth, and sixth protruding members 226, 228, 230, 232, 234, and 236 may be exposed to define the a reflective surface on one or more of the first, second, third, fourth, fifth, and sixth functional surfaces 238, 240, 242, 244, 246, and 248. In some examples, the exposed base metal layer may be polished to promote reflectivity thereof.

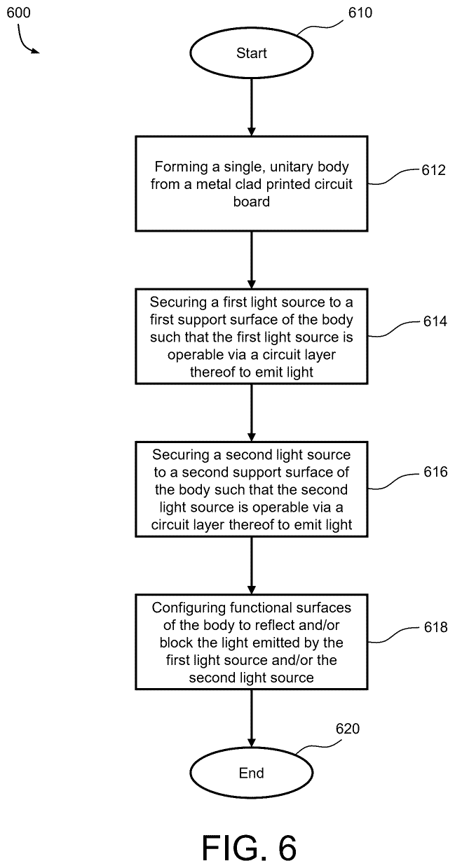

Referring to FIG. 6, a flowchart is provided illustrating an exemplary method 600 for producing a lighting device, such as the lighting devices 14 or 200. The method 600 may start at 610.

At 612, the method 600 may include forming a single, unitary body from a metal clad printed circuit board having at least a base metal layer, a circuit layer, and a dielectric layer between the base metal layer and the circuit layer. Forming the body may include providing a first support member having a first support surface, providing a second support member having a second support surface, wherein the first support member and the second support member are integral with each other with a bend at a boundary therebetween, providing a first protruding member integral with and extending from the first support member, the first protruding member having a first functional surface, providing a second protruding member integral with and extending from the first support member, the second protruding member having a second functional surface, providing a third protruding member integral with and extending from the second support member, the third protruding member having a third functional surface, providing a fourth protruding member integral with and extending from the second support member, the fourth protruding member having a fourth functional surface.

At 614, the method 600 may include securing a first light source to the first support surface such that the first light source is operable via the circuit layer to emit light. At 616, the method 600 may include securing a second light source to the second support surface such that the second light source is operable via the circuit layer to emit light. The first functional surface and the second functional surface may each be located within paths of light emitted from the first light source, and the third functional surface and the fourth functional surface may each be located within paths of light emitted from the second light source.

At 618, the method 600 may include configuring the first functional surface and the second functional surface to reflect and/or block the light emitted by the first light source, and configuring the third functional surface and the fourth functional surface to reflect and/or block the light emitted by the second light source. The method 600 may end at 620.

In some embodiments, the method 600 may include exposing the base metal layer on one or more of the first protruding member, the second protruding member, the third protruding member, and the fourth protruding member to define one or more of the first functional surface, the second functional surface, the third functional surface, and the fourth functional surface. In such embodiments, the exposed base metal layer may be configured to be reflective, for example, by a polishing process. In some embodiments, exposing the base metal layer may include removing the circuit layer and the dielectric layer from the one or more of the first protruding member, the second protruding member, the third protruding member, and the fourth protruding member, for example, with a chemical mechanical polishing process.

The lighting devices, systems, and methods disclosed herein provide various benefits over certain existing systems and methods. For example, the lighting devices may include fewer parts relative to existing lighting devices and therefore promote ease of assembly, ease of installation, and/or reduced manufacturing costs.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

As used herein, the term “substantially” denotes within 5% to account for manufacturing tolerances. Also, as used herein, the term “about” denotes within 5% to account for manufacturing tolerances.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A lighting device, comprising:
a single, unitary body formed of a metal clad printed circuit board having at least a base metal layer, a circuit layer, and a dielectric layer between the base metal layer and the circuit layer, the body comprising:
a first support member having a first support surface;
a second support member having a second support surface, wherein the first support member and the second support member are integral with each other with a bend at a boundary therebetween;
a first protruding member integral with and extending from the first support member, the first protruding member having a first functional surface;
a second protruding member integral with and extending from the first support member, the second protruding member having a second functional surface;
a third protruding member integral with and extending from the second support member, the third protruding member having a third functional surface; and
a fourth protruding member integral with and extending from the second support member, the fourth protruding member having a fourth functional surface,
a first light source fixed to the first support surface and configured to emit light therefrom, wherein the first light source is operable via the circuit layer, wherein the first functional surface and the second functional surface are each disposed within paths of light emitted from the first light source and configured to reflect and/or block the light emitted by the first light source; and
a second light source fixed to the second support surface and configured to emit light therefrom, wherein the second light source is operable via the circuit layer, wherein the third functional surface and the fourth functional surface are each disposed within paths of light emitted from the second light source and configured to reflect and/or block the light emitted by the second light source.

2. The lighting device of claim 1, wherein one or more of the first functional surface, the second functional surface, the third functional surface, and the fourth functional surface are reflective due to the base metal layer being exposed on one or more of the first protruding member, the second protruding member, the third protruding member, and the fourth protruding member.

3. The lighting device of claim 1, further comprising reflective tape bonded to one or more of the first protruding member, the second protruding member, the third protruding member, and the fourth protruding member, wherein the reflective tape defines one or more of the first functional surface, the second functional surface, the third functional surface, and the fourth functional surface, wherein the reflective tape is configured to reflect light.

4. The lighting device of claim 1, wherein the body is configured to be installed on an aircraft with the first light source and the second light source functionally coupled via the circuit layer to an electrical system of the aircraft such that the first light source and the second light source are each independently operable to emit light from the aircraft.

5. The lighting device of claim 4, wherein inboard surfaces of the first support member and the second support member are configured to be exposed to atmosphere during operation of the aircraft.

6. The lighting device of claim 1, further comprising:
a third support member of the body having a third support surface, wherein the second support member and the third support member are integral with each other with a bend at a boundary therebetween;
a fifth protruding member of the body integral with and extending from the third support member, the fifth protruding member having a fifth functional surface;
a sixth protruding member of the body integral with and extending from the third support member, the sixth protruding member having a sixth functional surface; and
a third light source fixed to the third support surface and configured to emit light therefrom, wherein the third functional surface is disposed within a path of light emitted from the third light source and configured to reflect and/or block the light emitted by the third light source.

7. The lighting device of claim 6, wherein the first support surface has a first axis extending between ends thereof, the second support surface has a second axis extending between ends thereof, and the third support surface has a third axis extending between ends thereof, wherein the first axis and the second axis define a first angle and the first axis and the third axis define a second angle, wherein absolute values of each of the first axis and the second axis are 120 to 140 degrees.

8. A method, the method comprising:
forming a single, unitary body from a metal clad printed circuit board having at least a base metal layer, a circuit layer, and a dielectric layer between the base metal layer and the circuit layer, wherein forming the body includes:
providing a first support member having a first support surface;
providing a second support member having a second support surface, wherein the first support member and the second support member are integral with each other with a bend at a boundary therebetween;
providing a first protruding member integral with and extending from the first support member, the first protruding member having a first functional surface;
providing a second protruding member integral with and extending from the first support member, the second protruding member having a second functional surface;
providing a third protruding member integral with and extending from the second support member, the third protruding member having a third functional surface; and
providing a fourth protruding member integral with and extending from the second support member, the fourth protruding member having a fourth functional surface;
securing a first light source to the first support surface such that the first light source is operable via the circuit layer to emit light, wherein the first functional surface and the second functional surface are each within paths of light emitted from the first light source;
securing a second light source to the second support surface such that the second light source is operable via the circuit layer to emit light, wherein the third functional surface and the fourth functional surface are each within paths of light emitted from the second light source;
configuring the first functional surface and the second functional surface to reflect and/or block the light emitted by the first light source; and
configuring the third functional surface and the fourth functional surface to reflect and/or block the light emitted by the second light source.

9. The method of claim 8, further comprising exposing the base metal layer on one or more of the first protruding member, the second protruding member, the third protruding member, and the fourth protruding member to define one or more of the first functional surface, the second functional surface, the third functional surface, and the fourth functional surface, wherein exposed portions of the base metal layer are reflective.

10. The method of claim 9, wherein exposing the base metal layer includes removing the circuit layer and the dielectric layer from the one or more of the first protruding member, the second protruding member, the third protruding member, and the fourth protruding member.

11. The method of claim 8, further comprising securing reflective tape to one or more of the first protruding member, the second protruding member, the third protruding member, and the fourth protruding member to define one or more of the first functional surface, the second functional surface, the third functional surface, and the fourth functional surface, wherein the reflective tape is configured to reflect light.

12. The method of claim 8, further comprising securing the body to an aircraft and functionally coupling the circuit layer to an electrical system of the aircraft such that the first light source and the second light source are each independently operable to emit light from the aircraft.

13. The method of claim 12, further comprising configuring inboard surfaces of the first support member, the second support member, and the third support member facing exterior surfaces of the aircraft to be exposed to atmosphere during operation of the aircraft.

14. The method of claim 8, wherein forming the body includes:
providing a third support member of the body having a third support surface, wherein the second support member and the third support member are integral with each other with a bend at a boundary therebetween;
providing a fifth protruding member of the body integral with and extending from the third support member, the fifth protruding member having a fifth functional surface;
providing a sixth protruding member of the body integral with and extending from the third support member, the sixth protruding member having a sixth functional surface;
securing a third light source to the third support surface such that the third light source is operable via the circuit layer to emit light, wherein the fifth protruding member and the sixth protruding member are both disposed within a path of light emitted from the third light source; and
configuring the fifth functional surface and the sixth functional surface to each reflect and/or block the light emitted by the third light source.

15. A vehicle, comprising:
a lighting device secured to an exterior of the vehicle, the lighting device including:
a single, unitary body formed of a metal clad printed circuit board having at least a base metal layer, a circuit layer, and a dielectric layer between the base metal layer and the circuit layer, the body comprising:
a first support member having a first support surface;
a second support member having a second support surface, wherein the first support member and the second support member are integral with each other with a bend at a boundary therebetween;
a first protruding member integral with and extending from the first support member, the first protruding member having a first functional surface;
a second protruding member integral with and extending from the first support member, the second protruding member having a second functional surface;
a third protruding member integral with and extending from the second support member, the third protruding member having a third functional surface;
a fourth protruding member integral with and extending from the second support member, the fourth protruding member having a fourth functional surface,
a first light source fixed to the first support surface and configured to emit light therefrom, wherein the first light source is operable via the circuit layer, wherein the first functional surface and the second functional surface are each disposed within paths of light emitted from the first light source and configured to reflect and/or block the light emitted by the first light source; and
a second light source fixed to the second support surface and configured to emit light therefrom, wherein the second light source is operable via the circuit layer, wherein the third functional surface and the fourth functional surface are each disposed within a path of light emitted from the second light source and configured to reflect and/or block the light emitted by the second light source;
a user interface functionally coupled to the lighting device via the circuit layer and configured to selectively operate the first light source and the second light source to emit light therefrom; and
a power supply functionally coupled to the lighting device via the circuit layer and configured to provide electrical power thereto.

16. The vehicle of claim 15, wherein one or more of the first functional surface, the second functional surface, the third functional surface, and the fourth functional surface of the body of the lighting device are reflective due to the base metal layer being exposed on one or more of the first protruding member, the second protruding member, the third protruding member, and the fourth protruding member.

17. The vehicle of claim 15, wherein the lighting device further includes reflective tape bonded to one or more of the first protruding member, the second protruding member, the third protruding member, and the fourth protruding member, wherein the reflective tape defines one or more of the first functional surface, the second functional surface, the third functional surface, and the fourth functional surface, wherein the reflective tape is configured to reflect light.

18. The vehicle of claim 15, wherein the lighting device further includes:
a third support member of the body having a third support surface, wherein the second support member and the third support member are integral with each other with a bend at a boundary therebetween;
a fifth protruding member of the body integral with and extending from the third support member, the fifth protruding member having a fifth functional surface;
a sixth protruding member of the body integral with and extending from the third support member, the sixth protruding member having a sixth functional surface; and
a third light source fixed to the third support surface and configured to emit light therefrom, wherein the third functional surface is disposed within a path of light emitted from the third light source and configured to reflect and/or block the light emitted by the third light source.

19. The vehicle of claim 18, wherein the body of the lighting device defines a space between inboard surfaces of the first support member, the second support member, and the third support member, and oppositely disposed portions of the exterior of the vehicle, wherein at least some of the inboard surfaces of the first support member, the second support member, the third support member are exposed to atmosphere.

20. The vehicle of claim 15, wherein the vehicle is an aircraft and one or both of the first light source and the second light source may be configured to function as a navigation light, a strobe light, an anti-collision light, a taxi light, a landing light, or a wing light of the aircraft.
